(19) United States
(12) Patent Application Publication
(10) Pub. No.: US 2010/0201504 A1
(43) Pub. Date: Aug. 12, 2010

(54) Emergency cars visual device (ECVD)

(76) Inventor: Cornel Preda, Cumming, GA (US)

Correspondence Address: Cornel Preda, 8520 Shade Springs Ct., Cumming, GA, 30028, US

(21) Appl. No.: 12/322,632

(22) Filed: Feb. 6, 2009

(51) Int. Cl. B60Q 1/00

(52) U.S. Cl. 340/425.5

(57) ABSTRACT

The Insulating Board System is a procedure where an insulation is added to any panel made from wood, cement, siding, or sheetrock, as a way to improve the R-value, the noise reduction and vibration, and improve the structure resistance of the construction.

### CROSS-REFERENCE TO RELATED APPLICATIONS

None

### FEDERALLY SPONSORED RESEARCH

None

### SEQUENCE LISTING

None

### BACKGROUND

The idea came to me when I was working to remodel an old house in Atlanta, Ga. The walls had no insulation and they were 2×4 framed. After putting the R-13 insulation I asked myself what else I can do to increase the R-value of the house. Then the idea of this type of insulation, the Insulating Board System, came to mind. It is an insulation applied to the inside or outside of the frame in addition to the regular insulation. The insulation is glue to the board (wood, cement board, siding, and even sheetrock) which help increase the R-value of the house, making it more energy efficient, better sound proof, less vibration, and give more structure resistance.

### DRAWINGS

FIG. 1 is a view of the 4×8 panel having in the middle insulation.

FIG. 2 is the view of the 4×8 sheetrock panel where the insulation is attach to.

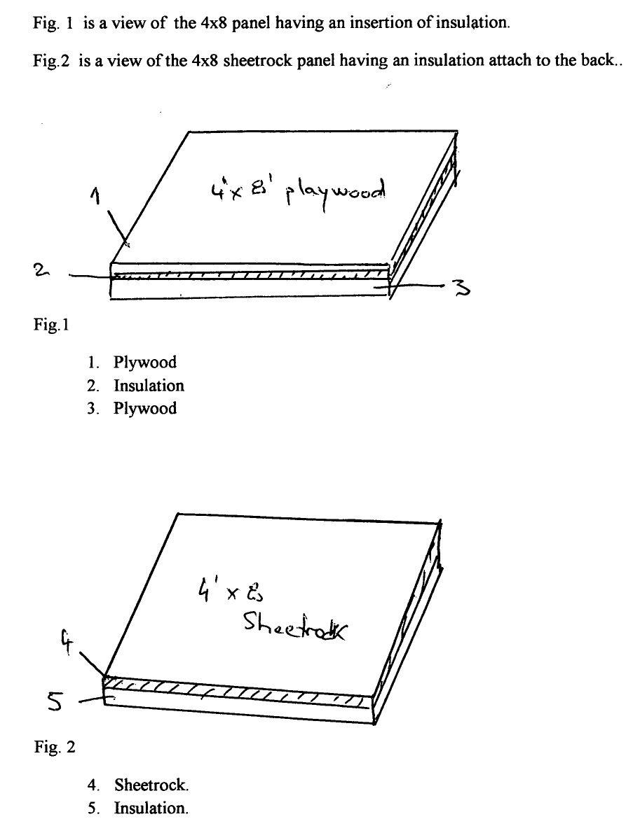

### DETAILED DESCRIPTION

On wood panels. The most used material for construction is the 4×8, ½′ OSB panels or plywood, by applying the insulation on the back of the panel the R-value increases with almost 20% for a regular 2×4 wall structure.

More that that the insulation could be inserted between layers of wood making the result panel more resistant and in the same time helping to the R-value of the construction, making the house more energy efficient. There are so many variable that can be achieved by the manufactory by playing with the thickness of the wood panel and with thickness of the insulation having as result a product that could be custom made.

On cement boards, insulation could be used to make a barrier between the subfloor and the floor to help with insulating bathrooms floors, kitchen floors and other applications.

Even the siding of the house could be improved by having a special insulation on the back to help increase the insulation factor of a house.

On the sheetrock board. The same system can be used for insulating the interior of the house. The exterior walls can be better protected by having an insulation apply to the back of the sheetrock raising the R-value with an additional 20%.

### OPERATION

The insulation is applied to the back of the panels, or it could be inserted between the layers of the wood to achieve the desired product. The insulation could be in form of: panels—as the polystyrene glue to the panel, or foam which could by pour between the layers. The thickness of the layer could be decided after the destination and the specification of the panel.

1. The Insulating Board System (IBS)
a) Increase the R-value of the house by 20% if applied only outside—in addition to OSB, or inside with 20% in addition with sheetrock. Combined, it could rise the R-value of the construction with more that 40%
b) Improve the resistance of the construction.
c) It helps reduce the vibrations that the structures face during years of use.
d) It helps reduce the noise. It reduce the noise that come from the outside when the insulation is places in the walls, and reduce noise between the floors when the insulation is placed between layers of wood panels used as subflooring. Give time to the drivers to make room for the emergency cars.
